(19) United States
(12) Patent Application Publication
(10) Pub. No.: US 2018/0307662 A1
(43) Pub. Date: Oct. 25, 2018

(54) INFORMATION PROCESSING APPARATUS, INFORMATION PROCESSING METHOD, AND NON-TRANSITORY COMPUTER READABLE MEDIUM

(71) Applicant: CANON KABUSHIKI KAISHA, Tokyo (JP)

(72) Inventor: Hirotaka Oda, Tokyo (JP)

(21) Appl. No.: 15/951,284

(22) Filed: Apr. 12, 2018

(30) Foreign Application Priority Data
Apr. 20, 2017 (JP) 2017-083418

(51) Int. Cl. G06F 17/24; G06F 17/22; G06F 17/21

(52) U.S. Cl. CPC G06F 17/24; G06F 17/212; G06F 17/2288

(57) ABSTRACT

An information processing apparatus according to the present invention, includes: a copying unit configured to copy a page of contents, having at least one page constituted by a main portion, to which main information is inputted, and an auxiliary portion, to which information to support the information in the main portion is inputted, as a new page of the contents; an editing unit configured to edit the new page in accordance with an operation by a user; and a notifying unit configured to notify the user of first information related to the auxiliary portion on the new page in accordance with an editing state of the new page.

### BACKGROUND OF THE INVENTION

### Field of the Invention

The present invention relates to an information processing apparatus, an information processing method, and a non-transitory computer readable medium.

### Description of the Related Art

In computer devices, presentation contents, having at least one page which includes a slide and an attached note, have been created by executing a presentation application program.

### SUMMARY OF THE INVENTION

To create the presentation contents (contents), the major information (main information; text) is inputted to a slide, and information that supports the information in the slide (auxiliary information; memo, annotation or the like) is inputted to the attached note. Therefore “slide” can be regarded as the “main portion”, and “attached note” can be regarded as the “auxiliary portion”. For example, the main information is information widely presented to third parties, and the auxiliary information is information required for specific individuals, such as the creator and concerned parties. Generally there are less opportunities to display an attached note (auxiliary information) than opportunities to display a slide (main information).

Further, when contents are created, a page of the contents may be copied as a new page (additional page) of the contents, so that the new page is edited. However, when a new page is edited, it is common that only the slide portion is edited, and the attached note is not edited. In such a case, the information in the slide and the information in the attached note may become inconsistent. And the creator (user) may not notice this inconsistency because the attached note is not always displayed.

With the foregoing in view, it is an object of the present invention to provide a technique to detect the possibility of the generation of an inconsistency between information in the auxiliary portion and the other information on a page, and allow the user to notice this easily and resolve the inconsistency.

The present invention in its first aspect provides an information processing apparatus, comprising:

a copying unit configured to copy a page of contents, having at least one page constituted by a main portion, to which main information is inputted, and an auxiliary portion, to which information to support the information in the main portion is inputted, as a new page of the contents;

an editing unit configured to edit the new page in accordance with an operation by a user; and

a notifying unit configured to notify the user of first information related to the auxiliary portion on the new page in accordance with an editing state of the new page.

The present invention in its second aspect provides an information processing apparatus, comprising:

an editing unit configured to edit a page of contents having at least one page constituted by a main portion, to which main information is inputted, and an auxiliary portion to which information to support the information in the main portion is inputted, in accordance with an operation by a user; and

a notifying unit configured to notify the user of information related to the auxiliary portion on the page in accordance with an editing state of the page.

The present invention in its third aspect provides an information processing method, comprising:

copying a page of contents, having at least one page constituted by a main portion, to which main information is inputted, and an auxiliary portion, to which information to support the information in the main portion is inputted, as a new page of the contents;

editing the new page in accordance with an operation by a user; and

notifying the user of information related to the auxiliary portion on the new page in accordance with an editing state of the new page.

The present invention in its fourth aspect provides an information processing method, comprising:

editing a page of contents having at least one page constituted by a main portion, to which main information is inputted, and an auxiliary portion to which information to support the information in the main portion is inputted, in accordance with an operation by a user; and

notifying the user of information related to the auxiliary portion on the page in accordance with an editing state of the page.

The present invention in its fifth aspect provides a non-transitory computer readable medium that stores a program, wherein the program causes a computer to execute:

copying a page of contents, having at least one page constituted by a main portion, to which main information is inputted, and an auxiliary portion, to which information to support the information in the main portion is inputted, as a new page of the contents;

editing the new page in accordance with an operation by a user; and

notifying the user of information related to the auxiliary portion on the new page in accordance with an editing state of the new page.

The present invention in its sixth aspect provides a non-transitory computer readable medium that stores a program, wherein the program causes a computer to execute:

editing a page of contents having at least one page constituted by a main portion, to which main information is inputted, and an auxiliary portion to which information to support the information in the main portion is inputted, in accordance with an operation by a user; and

notifying the user of information related to the auxiliary portion on the page in accordance with an editing state of the page.

According to the present invention, the user can easily notice the generation of an inconsistency between the information in the auxiliary portion and the other information on a page, and resolve the inconsistency.

Further features of the present invention will become apparent from the following description of exemplary embodiments with reference to the attached drawings.

### BRIEF DESCRIPTION OF THE DRAWINGS

FIG. 1 is a block diagram depicting a configuration example an information processing apparatus according to this embodiment;

FIGS. 2A and 2B show an example of a conventional screen;

FIGS. 3A and 3B show an example of a screen according to this embodiment;

FIG. 4 is an example of a data configuration of a page according to this embodiment;

FIG. 5 is a flow chart depicting an example of the processing flow of editing processing according to this embodiment;

FIG. 6 is a flow chart depicting an example of the processing flow of heading editing processing according to this embodiment;

FIG. 7 is a flow chart depicting an example of the processing flow of main editing processing according to this embodiment; and

FIG. 8 is a flow chart depicting an example of the processing flow of auxiliary editing processing according to this embodiment.

### DESCRIPTION OF THE EMBODIMENTS

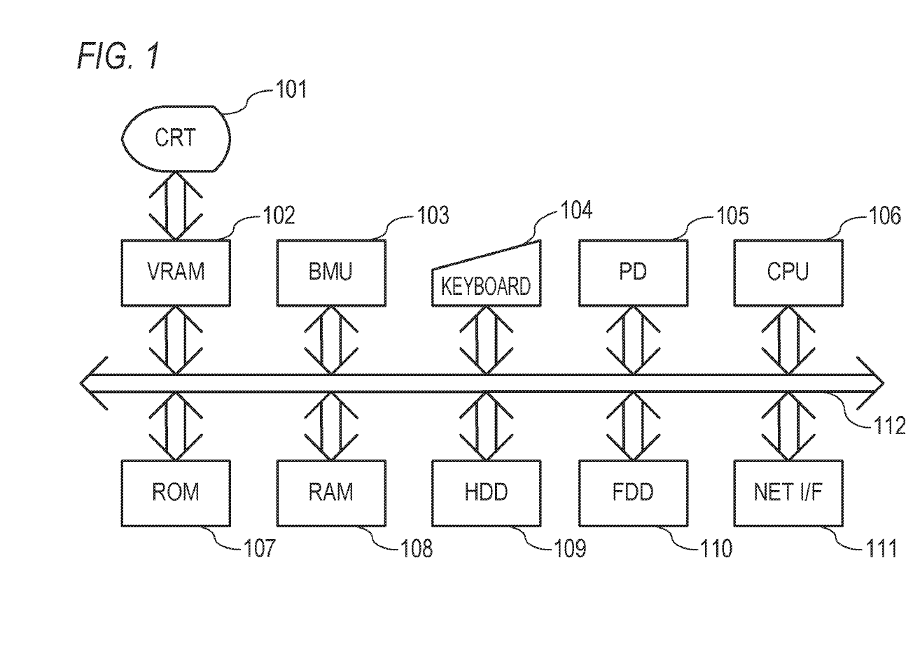

An embodiment of the present invention will be described with reference to the drawings. FIG. 1 is a block diagram depicting a configuration example of an information processing apparatus according to this embodiment. The information processing apparatus is, for example, a personal computer, a PDA, a smartphone, a tablet terminal or the like. The information processing apparatus in FIG. 1 includes a CRT display unit 101, a VRAM 102, a BMU 103, a keyboard 104, a PD 105, a CPU 106, a ROM 107, a RAM 108, an HDD 109, an FDD 110, a network I/F 111 and a bus 112.

The CRT display unit 101 is a display unit to display various information. For example, the CRT display unit 101 displays icons, messages, menus and other user interface information to manage the information processing apparatus. The CRT display unit 101 may be a device that is separate from the information processing apparatus. Instead of the CRT display unit 101, a liquid crystal display unit, an organic EL display unit or the like may be used.

The VRAM 102 stores image data to be displayed on the CRT display unit 101 (display surface of the CRT display unit 101). In other words, an image to be displayed on the CRT display unit 101 is recorded in the VRAM 102. The image data recorded in the VRAM 102 is transferred to the CRT display unit 101 according to a predetermined specification. Thereby an image based on the image data recorded in the VRAM 102 is displayed on the CRT display unit 101.

The beam move unit (BMU) 103 controls various data transfers. For example, the BMU 103 controls the data transfer between memories (e.g. between VRAM 102 and another memory), and the data transfer between a memory and an I/O device (e.g. network I/F 111).

The keyboard 104 receives operation from the user (user operation). For example, the keyboard 104 has various keys to input characters and the like. The keyboard 104 may be detachable from the information processing apparatus.

The pointing device (PD) 105 accepts the user operation. For example, the PD 105 is used to instruct or move an icon, a menu, an object or the like displayed on the CRT display unit 101. The PD 105 is a mouse or a touch panel, for example. The PD 105 may be detachable from the information processing apparatus.

The CPU 106 controls the processing of each device based on a control program, such as the OS and application programs, stored in the ROM 107, the HDD 109 or the FDD 110.

The ROM 107 stores various control programs, various data and the like.

The RAM 108 temporarily stores various data. The storage area of the RAM 108 includes a work area of the CPU 106, a data save area during error processing, and a load area of a control program.

The HDD 109 includes a hard disk to store various control programs and various data, and is used for reading data from a hard disk or writing data to a hard disk. The HDD 109 may be detachable from the information processing apparatus.

In the FDD 110, a flexible disk that stores various control programs and various data can be removably installed. The FDD 110 reads data from a flexible disk installed (inserted) in the FDD 110, or writes data to a flexible disk installed in the FDD 110. The FDD 110 may be detachable from the information processing apparatus.

The network I/F 111 is used to perform communication with another information processing apparatus, a printer or the like via a network.

The bus 112 includes an address bus, a data bus, a control bus, and is used for transmitting/receiving data between devices.

A control program may be provided from the ROM 107, the HDD 109 or the FDD 110 to the CPU 106, or may be provided from another device to the CPU 106 via the network I/F 111. The storage medium is not limited to a magnetic disk (e.g. hard disk, flexible disk) and a semiconductor memory (e.g. ROM 107). For example, an optical disk (e.g. CD, DVD, blue-ray disk) may be used as the storage medium. Further, a USB memory, an SSD or the like may be used as the storage medium (storage device).

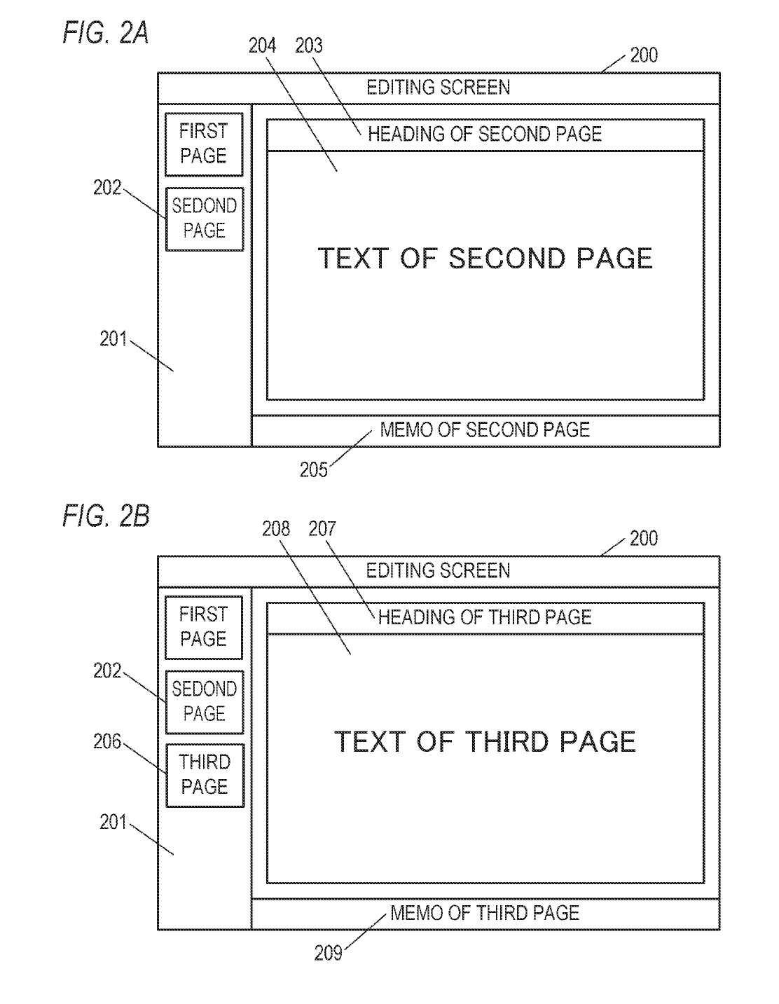

FIGS. 2A and 2B show an example of the conventional application screen 200 where contents having at least one page is created or edited. The screen 200 in FIG. 2A indicates the state when the second page of the contents is edited, and FIG. 2B indicates the state when the second page is copied as the third page of the contents, and the third page is edited.

In the thumbnail portion (thumbnail area) 201 on the screen 200, a list of the pages of the editing target contents is displayed. In concrete terms, in the thumbnail portion 201, the thumbnail image of each page of the editing target contents is displayed in page sequence. The thumbnail image 202 is the thumbnail image on the second page. In a heading portion (heading area) 203, the heading of the second page is displayed. In a main portion (main area) 204, the major information (main information; text) of the second page is displayed. In an auxiliary portion (auxiliary area) 205, the auxiliary information (information to support the information on the main area 204; memo, annotation, etc.) on the second page is displayed.

The thumbnail image 206 in FIG. 2B is the thumbnail image on the third page. In the heading portion 207, the heading on the third page is displayed. In the main portion 208, the main information on the third page is displayed. In the auxiliary portion 209, the auxiliary information on the third page is displayed. When the third page is generated, the heading on the third page is the same as the heading on the second page, the main information on the third page is the same as the main information on the second page, and the auxiliary information on the third page is the same as the auxiliary information on the second page.

In some cases, when the third page is edited, the auxiliary portion 209 may not be edited even if the main portion 208 is edited. In other words, in some cases, the auxiliary information on the third page remains the same as the auxiliary information on the second page, even if the main portion 208 is edited. In such a case, the information in the main portion 208 and the information in the auxiliary portion 209 may become inconsistent. In the same manner, when the heading portion 207 is edited and the auxiliary portion 209 is not edited, the information in the heading portion 207 and the information in the auxiliary portion 209 may become inconsistent. Thus on the third page, information in the auxiliary portion 209 and other information may be become inconsistent. In the prior art, the state in FIG. 2B is maintained even if such an inconsistency is generated, hence the user (e.g. creator, editor) cannot easily notice the generation of an inconsistency. As a result, the inconsistent contents may be created as the final contents.

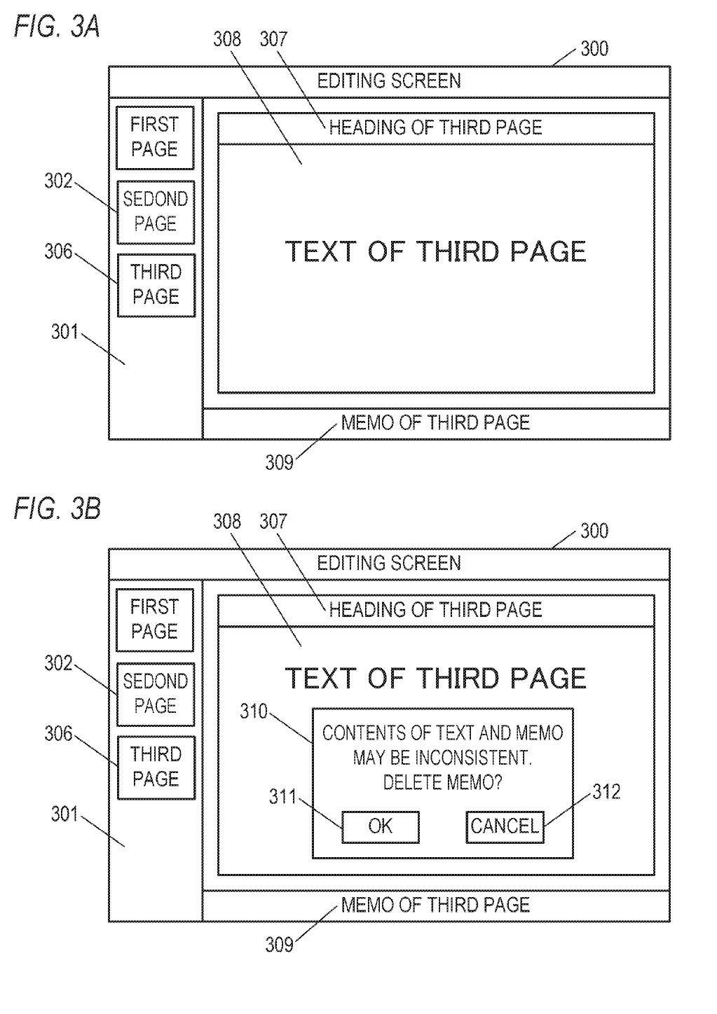

FIGS. 3A and 3B show an example of a screen 300 according to this embodiment. The screen 300 is an application screen to create or edit contents having at least one page. The screen 300 is displayed on the CRT display unit 101 by the CPU 106 executing a predetermined application program. If this application is used, the CPU 106 creates or edits the contents in accordance with the user operation, which is performed using the keyboard 104, the PD 105 or the like. The CPU 106 can also record, for instance, the created contents in the storing unit, or read the contents during creation from the storing unit, and edit the contents. Further, the CPU 106 can copy the (existent) page of the contents to the new page (additional page) of the contents. The phrase “processing to copy a page of contents as a new page of the contents” can be regarded as “processing to additionally generate a copied page of contents as a new page of the contents”. The screen 300 is not limited to the application screen.

The screen 300 in FIG. 3A indicates the state when the second page of the contents is copied as the third page of the contents, and the third page is edited. The screen 300 in FIG. 3B indicates the state after the third page is edited in accordance with the user operation. In concrete terms, the screen 300 in FIG. 3B is a state after the main portion on the third page is edited in accordance with the user operation. The screen 300 before the third page is generated is the screen 200 in FIG. 2A.

In the thumbnail portion 301 on the screen 300, a list of the pages of the editing target contents is displayed. In concrete terms, in the thumbnail portion 301, the thumbnail image of each page of the editing target contents is disposed in page sequence. The thumbnail image 302 is the thumbnail image on the second page, and the thumbnail image 306 is the thumbnail image on the third page. In a heading portion 307, the heading of the third page is displayed. In a main portion 308, the main information of the third page is displayed. In an auxiliary portion 309, the auxiliary information on the third page is displayed. The CPU 106 can input information for the heading portion 307, the main portion 308, and the auxiliary portion 309 in accordance with the user operation. The CPU 106 can also perform control to implement switching between display and non-display of the auxiliary portion 309.

The configuration of the screen or the page is not limited to the above configuration. For example, the screen need not include the thumbnail portion, and the page need not include the heading portion. The screen or the page may further include a portion that is different from the above mentioned portions.

In this embodiment, the CPU 106 notifies the user of the information related to the auxiliary portion of the new page in accordance with the state of editing the new page. In concrete terms, when it is determined that the editing may have caused an inconsistency between the information in the auxiliary portion and the other information on the page, the CPU 106 notifies the user of this information. Thereby the user can easily notice the generation of an inconsistency between the information in the auxiliary portion and the other information on the new page, and the user can resolve the inconsistency.

In this embodiment, as depicted in FIG. 3B, the CPU 106 controls to display a popup message screen (message) 310 on the CRT display unit 101, so as to notify the user of the information related to the auxiliary portion on the new page. In the popup message screen 310, a message “Contents of text and memo may be inconsistent” is displayed. In other words, the display on the popup message screen 310 notifies the user of the possibility of the generation of an inconsistency between the information in the auxiliary portion and the other information on the new page. Further, a message “Delete memo?” is displayed on the popup message screen 310. In the popup message screen 310, an OK button 311, for the user operation to delete the information in the auxiliary portion on the new page, and a CANCEL button 312, for the user operation to not delete the information in the auxiliary portion on the new page, are displayed. In other words, when the popup message screen 310 is displayed, information to prompt the user to perform the user operation of deleting the information in the auxiliary portion on the new page is also notified to the user.

In this embodiment, the CPU 106 detects common information (e.g. common words), which is common to the information in the main portion and the information in the auxiliary portion before editing, on the new page. The CPU 106 also detects the difference between the information in the main portion before editing and the information in the main portion after editing on the new page. This difference is hereafter called the “editing amount”. Then the CPU 106 performs control to display the popup message screen 310 for the following Cases 1 to 3 respectively. The threshold in Case 3 may be a value predetermined by the manufacturer, or a value specified by the user.

Case 1: The heading portion (predetermined portion) on the new page is edited.
Case 2: The common information is deleted from the main portion on the new page.
Case 3: The ratio of the editing amount with respect to the information in the main portion before editing on the new page exceeds a threshold.

The method of determining whether or not the popup message screen 310 is displayed is not limited to the above mentioned method. For example, the popup message screen 310 need not be displayed in any of Cases 1 to 3. The popup message screen 310 may be displayed when the main portion on the new page is even slightly edited. The popup message screen 310 may not be displayed when at least one of the main portion and the auxiliary portion on the new page does not include information. The popup message screen 310 may not be displayed after the auxiliary portion on the new page is edited. The predetermined portion need not be the heading portion.

The information related to the auxiliary portion on the new page is not limited to the information including both the information which indicates the possibility of the generation of an inconsistency between the information in the auxiliary portion and the other information on the new page, and the information to prompt the user to perform user operation of deleting the information in the auxiliary portion on the new page. For example, the information related to the auxiliary portion on the new page may correspond to one of the above two types of information. The information related to the auxiliary portion on the new page may be information that is different from the two types of information mentioned above.

When the information in the auxiliary portion on the new page is deleted, responding to the abovementioned information notice (e.g. user operation to press the OK button 311), the CPU 106 may notify the user of other information. The other information is not especially limited, but is, for example, information to indicate that the information in the auxiliary portion on the new page is deleted. Thereby the user can easily notice that the information in the auxiliary portion on the new page is deleted.

The method of notification on the information related to the auxiliary portion on the new page is not limited to the above method. The information may be notified by a control to highlight the auxiliary portion on the new page (e.g. a control to implement blinking display). The information may be notified by a control to implement switching between display and non-display of the auxiliary portion on the new page is displayed (e.g. a control to display the auxiliary portion in a non-display state). The information may be notified by other methods.

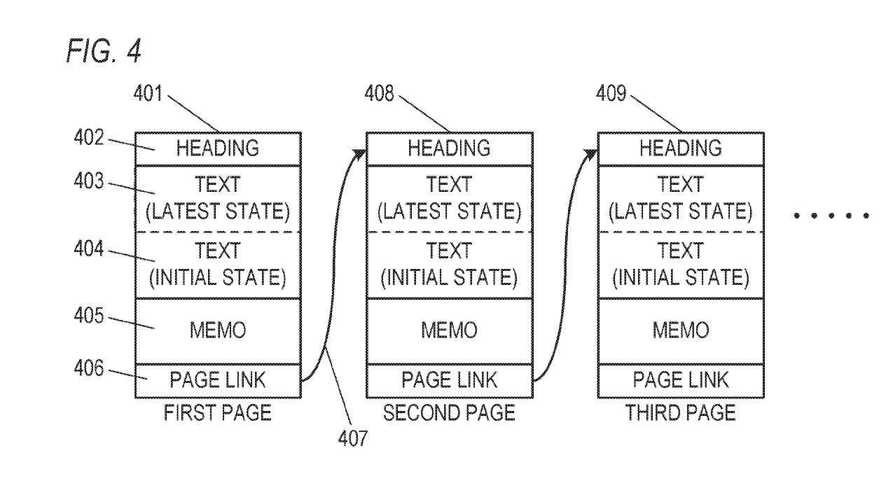

FIG. 4 is an example of a data configuration of a page according to this embodiment. The data on each page includes heading data 402, current main data 403, previous main data 404, auxiliary data 405, and link data 406.

The heading data 402 includes information in the heading portion (e.g. current information; character string), and attribute information that indicates an attribute related to this information. The current main data 403 includes information (e.g. current information, latest information, character string, and graphics) in the main portion, and attribute information that indicates an attribute related to this information. The previous main data 404 includes information that was in the main portion at the timing when the auxiliary portion was edited (e.g. character string, graphics), and attribute information that indicates an attribute related to this information. The auxiliary data 405 includes information (e.g. current information and character string) in the auxiliary portion, and attribute information that indicates an attribute related to this information.

The CPU 106 can determine the editing amount, the ratio of the editing amount with respect to the information in the main portion before editing and the like by comparing the current main data 403 and the previous main data 404. Further, the CPU 106 can determine the common information by comparing the previous main data 404 and the auxiliary data 405.

The link data 406 includes the link information 407 that indicates data on the next page. For example, the link data 406 of the data 401 on the first page includes the link information 407 that indicates the data 408 on the second page. When the copy of the data 408 on the second page is generated as the data 409 on the third page, the CPU 106 updates the link data 406 of the data 408 and 409 respectively. For example, the link data 406 of the data 408 on the second page include the link information 407 that indicates the data 409 on the third page. The data on the last page does not includes the link information 407, for example, or include the link information 407 that indicates the data on the first page.

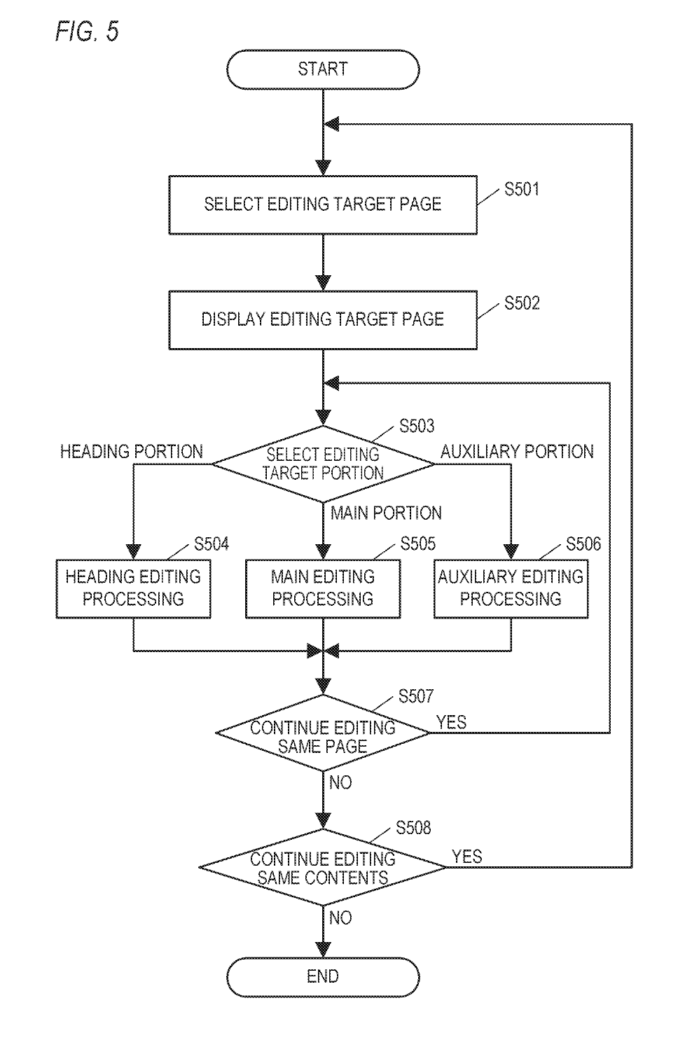

FIG. 5 is a flow chart depicting an example of the processing flow of the editing processing of the information processing apparatus (application to create or edit contents) according to this embodiment.

First in S501, the CPU 106 selects the editing target page in accordance with the user operation. For example, in accordance with the user operation to specify a thumbnail image disposed in the thumbnail portion 301, the CPU 106 selects a page corresponding to the specified thumbnail image as the editing target.

Then in S502, the CPU 106 performs a control to display the page selected in S501 on the CRT display unit 101. Thereby the information based on the heading data 402 on the editing target page is displayed as the information in the heading portion. The information based on the current main data 403 on the editing target page is displayed as the information in the main portion. And the information based on the auxiliary data 405 on the editing target page is displayed as the information in the auxiliary portion.

Then in S503, the CPU 106 selects one of the heading portion, the main portion and the auxiliary portion on the editing target page as the editing target portion in accordance with the user operation. For example, in accordance with the user operation to select one of the heading portion, the main portion and the auxiliary portion, the CPU 106 selects the specified portion as the editing target portion. If the heading portion is selected as the editing target portion, processing advances to S504. If the main portion is selected as the editing target portion, processing advances to S505. And if the auxiliary portion is selected as the editing target portion, processing advances to S506.

In S504, the CPU 106 performs the heading editing processing. In S505, the CPU 106 performs the main editing processing. And in S506, the CPU 106 performs the auxiliary editing processing. If any of the processing operations in S504 to S506 end, processing advances to S507. Details on the processing operations in S504 to S506 will be described later.

In S507, the CPU 106 determines whether or not the user instructed for continuation of editing the same page. If the user instructed for continuation of editing the same page, processing returns to S503, and if not, processing advances to S508.

In S508, the CPU 106 determines whether or not the user instructed for continuation of editing the same contents (another page). If the user instructed for continuation of editing the same contents, processing returns to S501, and if not, this processing flow ends.

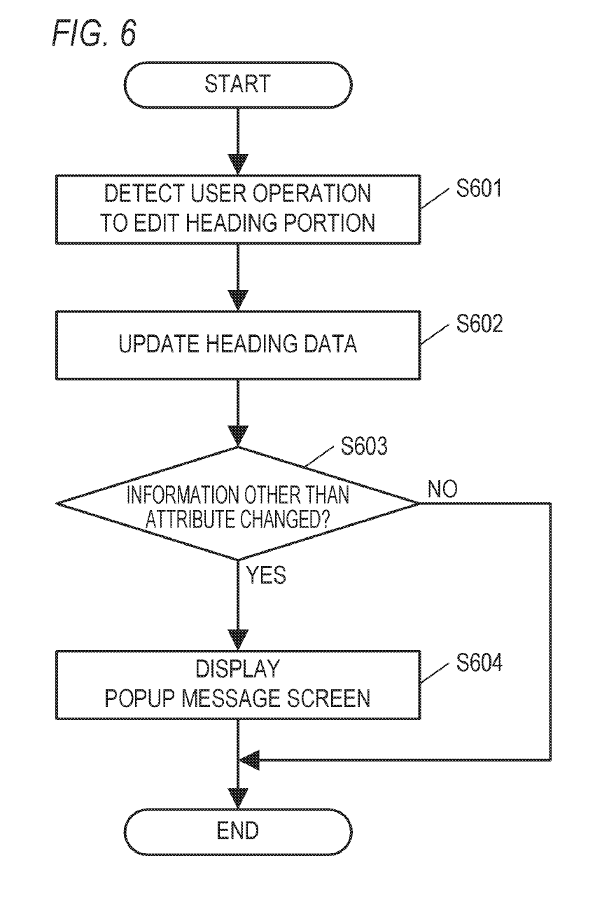

FIG. 6 is a flow chart depicting an example of the processing flow of the heading editing processing (S504 in FIG. 5) of the information processing apparatus (application to create or edit contents) according to this embodiment.

First in S601, the CPU 106 detects the user operation to edit the heading portion of the editing target. For example, the CPU 106 detects the user operation to input information, including an attribute (e.g. character string) to the heading portion of the editing target.

Then in S602, the CPU 106 updates the heading data 402 on the editing target page in accordance with the user operation detected in S601.

Then in S603, the CPU 106 determines whether or not the information in the heading portion (information other than an attribute) was changed by the processing in S602. If the information in the heading portion was changed, it is determined that an inconsistency may have been generated between the information in the heading portion and the information on the auxiliary portion. It is also determined that an inconsistency may have been generated between the information in the handling portion and the information in the main portion. Therefore processing advances to S604. If the information in the heading portion was not changed, it can be determined that the above mentioned possibility did not occur (or that possibility is low), therefore this processing flow ends.

In S604, the CPU 106 performs a control to display the popup message screen 310. Then this processing flow ends.

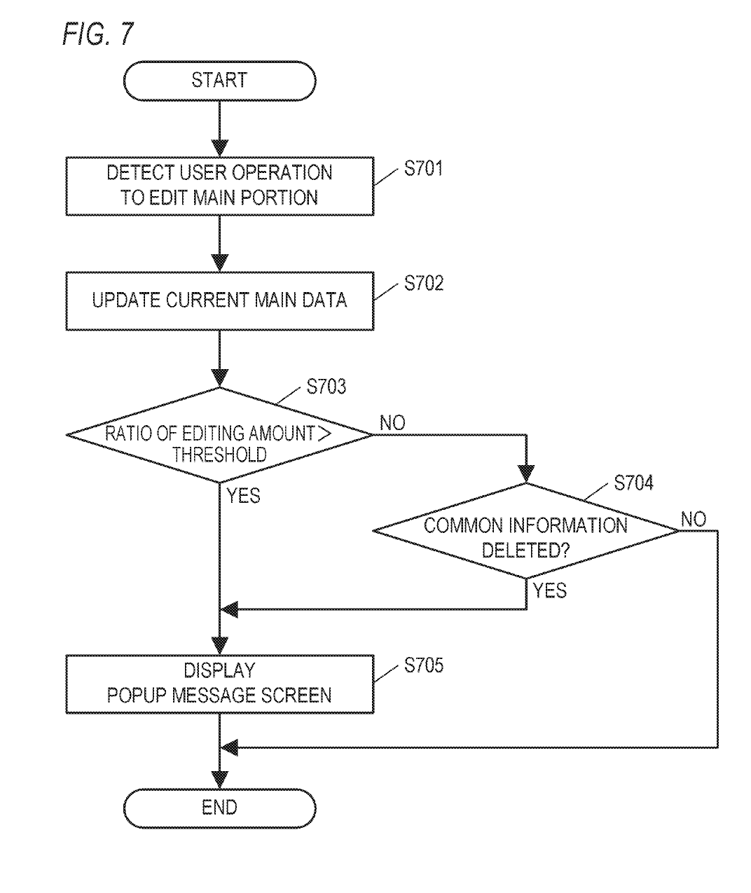

FIG. 7 is a flow chart depicting an example of the processing flow of the main editing processing (S505 in FIG. 5) in the information processing apparatus (application to create or edit contents) according to this embodiment.

First in S701, the CPU 106 detects that the user operated to edit the main portion of the editing target. For example, the CPU 106 detects that the user operated to input information including an attribute (e.g. character string, graphics) to the main portion of the editing target.

Then in S702, the CPU 106 updates the current main data 403 on the editing target page in accordance with the user operation detected in S701.

Then in S703, the CPU 106 compares the current main data 403 updated in S702 (information in the main portion; information other than an attribute) with the previous main data 404 (information in the main portion; information other than an attribute). Thereby it is determined whether or not the ratio of the editing amount, with respect to the information in the main portion before the update, exceeded the threshold on the editing target page. If this ratio exceeded the threshold, it can be determined that the information in the main portion may have changed considerably, and an inconsistency may have been generated between the information in the main portion and the information in the auxiliary portion, therefore processing advances to S705. If the ratio did not exceed the threshold, processing advances to S704.

In S704, the CPU 106 determines whether or not common information (e.g. common words) that is common to the previous main data 404 and the auxiliary data 405 on the editing target page was deleted from the current main data 403 by the processing in S702. If the common information was deleted from the current main data 403, it can be determined that the information corresponding to a critical key word may have been changed, and an inconsistency may have been generated between the information in the main portion and the information of the auxiliary portion, therefore processing advances to S705. If the above mentioned ratio did not exceed the threshold and the common information was not deleted from the current main data 403, it can be determined that the above mentioned possibility did not occur (or that possibility is low), therefore this processing flow ends.

The processing in S704 may be performed before the processing in S703. In this case, processing returns from S704 to S703, since the common information was not deleted from the current main data 403.

In S705, the CPU 106 performs a control to display the popup message screen 310. Then this processing flow ends.

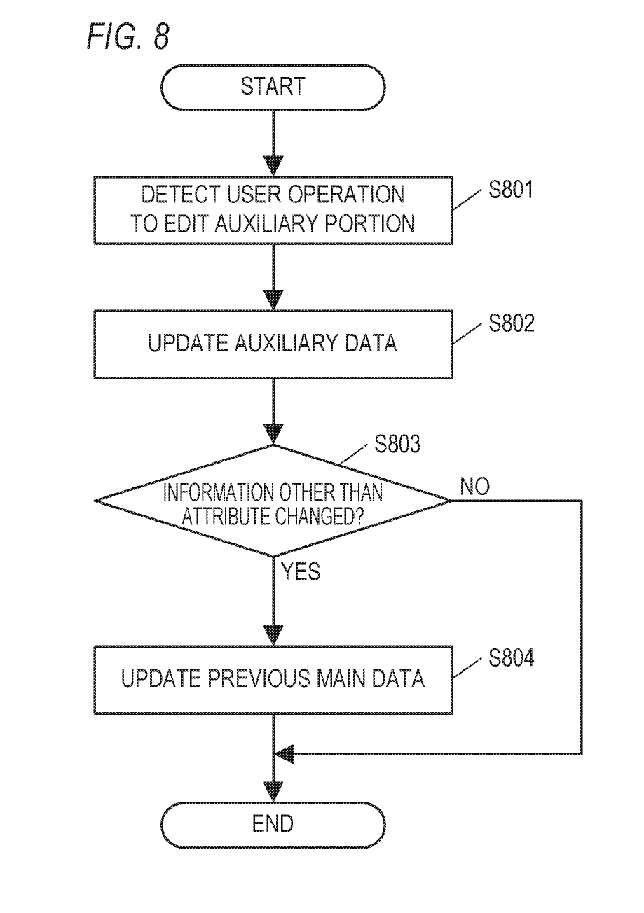

FIG. 8 is a flow chart depicting an example of the processing flow of the auxiliary editing processing (S506 in FIG. 5) in the information processing apparatus (application to create or edit contents) according to this embodiment.

First in S801, the CPU 106 detects that the user operated to edit the auxiliary portion of the editing target. For example, the CPU 106 detects that the user operated to input information, including an attribute (e.g. character string), to the auxiliary portion of the editing target.

Then in S802, the CPU 106 updates the auxiliary data 405 on the editing target page in accordance with the user operation detected in S801.

Then in S803, the CPU 106 determines whether or not the information in the auxiliary portion (information other than an attribute) was changed by the processing in S802. If the information in the auxiliary portion was changed, processing advances to S804. If the information in the auxiliary portion was not changed, this processing flow ends.

In S804, the CPU 106 updates the previous main data 404 to the current main data 403 on the editing target page. Thereby the current main data 403 at the timing when the auxiliary portion was edited can be used as the previous main data 404. After the processing in S804 is performed, this processing flow ends.

As described above, according to this embodiment, the information related to the auxiliary portion on the new page is notified to the user in accordance with the editing state of the new page. Thereby the user can easily notice the generation of an inconsistency between the information in the auxiliary portion and the other information on the new page, and can resolve the inconsistency. Further, according to this embodiment (processing flow in FIGS. 5 to 8), the information related to the auxiliary portion on a conventional page, other than the new page, can also be notified to the user in accordance with the editing state of the conventional page. Thereby the user can easily notice the generation of an inconsistency between the information in the auxiliary portion and the other information on the conventional page, and can resolve the inconsistency. The notification may be performed only for a new page. For example, the processing flow in FIGS. 5 to 8 may be performed only for the new page.

The present invention has been described based on a preferable embodiment thereof, but the present invention is not limited to this specific embodiment, but may include various modes in a range that does not depart from the essence of the invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

Therefore program codes that are supplied to or installed on a computer to implement the functional processing operations of the present invention also carry out the present invention. In other words, a computer program to implement a functional processing of the present invention is included in the present invention. In this case, the form of the program is not limited if the program function can be implemented, and may be, for example, object codes, a program executed by an interpreter, scripting data supplied to the OS and the like. For a storage medium to supply the program, a hard disk, a magnetic storage medium (e.g. magnetic tape), or an optical/magneto optical storage medium, or a non-volatile semiconductor memory can be used, for example. A possible method of supplying the program is recording the program to implement the present invention to a server on a computer network, and a client computer connected to the computer network downloading the program from the server.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-083418, filed on Apr. 20, 2017, which is hereby incorporated by reference herein in its entirety.

What is claimed is:

1. An information processing apparatus, comprising:
a copying unit configured to copy a page of contents, having at least one page constituted by a main portion, to which main information is inputted, and an auxiliary portion, to which information to support the information in the main portion is inputted, as a new page of the contents;
an editing unit configured to edit the new page in accordance with an operation by a user; and
a notifying unit configured to notify the user of first information related to the auxiliary portion on the new page in accordance with an editing state of the new page.

2. The information processing apparatus according to claim 1, wherein
the notifying unit notifies the user of the first information in a case where the main portion on the new page is edited.

3. The information processing apparatus according to claim 2, further comprising a first detecting unit configured to detect common information, which is common to information in the main portion before editing and information in the auxiliary portion, on the new page, wherein
the notifying unit notifies the user of the first information in a case where the common information is deleted from the main portion on the new page.

4. The information processing apparatus according to claim 2, further comprising a second detecting unit configured to detect a difference between the information in the main portion before editing and the information in the main portion after editing, on the new page, wherein
the notifying unit notifies the user of the first information in a case where a ratio of the difference with respect to the information in the main portion before editing exceeds a threshold.

5. The information processing apparatus according to claim 1, wherein
the page further includes a predetermined portion that is different from the main portion and the auxiliary portion, and
the notifying unit notifies the user of the first information in a case where the predetermined portion on the new page is edited.

6. The information processing apparatus according to claim 5, wherein
the predetermined portion is a portion to which a heading of the page is inputted.

7. The information processing apparatus according to claim 1, wherein
the notifying unit does not notify the user of the first information after the auxiliary portion on the new page is edited.

8. The information processing apparatus according to claim 1, wherein
the first information is at least one of information indicating the possibility of generation of an inconsistency between the information in the auxiliary portion and other information on the new page, and information prompting the user to perform an operation of deleting the information in the auxiliary portion on the new page.

9. The information processing apparatus according to claim 1, wherein
the first information is information prompting the user to perform an operation of deleting the information in the auxiliary portion on the new page, and
the notifying unit notifies the user of second information in a case where the information in the auxiliary portion on the new page is deleted responding to the notification of the first information.

10. The information processing apparatus according to claim 9, wherein
the second information is information indicating that the information in the auxiliary portion on the new page has been deleted.

11. The information processing apparatus according to claim 1, wherein
the notifying unit notifies the user of the first information by performing one of a control to display a message, a control to highlight and display the auxiliary portion on the new page, and a control to implement switching between display and non-display of the auxiliary portion on the new page.

12. An information processing apparatus, comprising:
an editing unit configured to edit a page of contents having at least one page constituted by a main portion, to which main information is inputted, and an auxiliary portion to which information to support the information in the main portion is inputted, in accordance with an operation by a user; and
a notifying unit configured to notify the user of information related to the auxiliary portion on the page in accordance with an editing state of the page.

13. An information processing method, comprising:
copying a page of contents, having at least one page constituted by a main portion, to which main information is inputted, and an auxiliary portion, to which information to support the information in the main portion is inputted, as a new page of the contents;
editing the new page in accordance with an operation by a user; and
notifying the user of information related to the auxiliary portion on the new page in accordance with an editing state of the new page.

14. An information processing method, comprising:
editing a page of contents having at least one page constituted by a main portion, to which main information is inputted, and an auxiliary portion to which information to support the information in the main portion is inputted, in accordance with an operation by a user; and
notifying the user of information related to the auxiliary portion on the page in accordance with an editing state of the page.

15. A non-transitory computer readable medium that stores a program, wherein the program causes a computer to execute:
copying a page of contents, having at least one page constituted by a main portion, to which main information is inputted, and an auxiliary portion, to which information to support the information in the main portion is inputted, as a new page of the contents;
editing the new page in accordance with an operation by a user; and
notifying the user of information related to the auxiliary portion on the new page in accordance with an editing state of the new page.

16. A non-transitory computer readable medium that stores a program, wherein the program causes a computer to execute:
editing a page of contents having at least one page constituted by a main portion, to which main information is inputted, and an auxiliary portion to which information to support the information in the main portion is inputted, in accordance with an operation by a user; and
notifying the user of information related to the auxiliary portion on the page in accordance with an editing state of the page.
